(19) United States
(12) Patent Application Publication
(10) Pub. No.: US 2025/0181974 A1
(43) Pub. Date: Jun. 5, 2025

(54) SYSTEMS AND METHODS FOR CONTROLLING A MOVEMENT OF A CHARACTER IN A VIRTUAL ENVIRONMENT

(71) Applicant: The University of North Carolina at Charlotte, Charlotte, NC (US)

(72) Inventors: Pu Wang, Charlotte, NC (US); Ekkasit Pinyoanuntapong, Charlotte, NC (US)

(21) Appl. No.: 18/961,864

(22) Filed: Nov. 27, 2024

Related U.S. Application Data
(60) Provisional application No. 63/604,305, filed on Nov. 30, 2023.

(51) Int. Cl. G06N 20/00

(52) U.S. Cl. CPC G06N 20/00

(57) ABSTRACT

A system for controlling a character in a virtual environment includes at least one processor and at least one nontransitory computer-readable medium comprising instructions that are executable by the at least one processor. The instructions include receiving a text input indicating one or more motions of the character, generating a plurality of text-based tokens and a plurality of motion tokens, appending a plurality of masked tokens to the plurality of motion tokens, performing a masked transformer routine to generate a plurality of predicted motion tokens based on the plurality of masked tokens, the plurality of motion tokens, and the plurality of text-based tokens, decoding the plurality of predicted motion tokens and the plurality of motion tokens into a motion sequence of the character, where the motion sequence includes the one or more motions and a predicted motion of the character, and controlling the character based on the motion sequence.

### CROSS-REFERENCE TO RELATED APPLICATION

This application claims priority to U.S. provisional application No. 63/604,305 filed on Nov. 30, 2023. The disclosure of the above application is incorporated herein by reference.

### FIELD

The present disclosure relates to systems and methods for controlling a movement of a character in a virtual environment.

### BACKGROUND

The statements in this section merely provide background information related to the present disclosure and may not constitute prior art.

Text-based character motion (e.g., human motion) generation systems of a virtual environment may be employed to control the movement of the virtual characters in animation, film, virtual reality (VR), augmented reality (AR), and robotic simulation environments. As an example, the text-based character motion generation systems may perform language-motion latent space alignment routines, conditional diffusion model routines, and/or conditional autoregressive model routines to control the movement of characters in a virtual environment based on text inputs.

### SUMMARY

This section provides a general summary of the disclosure and is not a comprehensive disclosure of its full scope or all of its features.

A system for controlling a character in a virtual environment includes at least one processor and at least one nontransitory computer-readable medium comprising instructions that are executable by the at least one processor. The instructions include receiving a text input indicating one or more motions of the character, generating, based on the text input, a plurality of text-based tokens and a plurality of motion tokens, appending a plurality of masked tokens to the plurality of motion tokens, performing a masked transformer routine to generate a plurality of predicted motion tokens based on the plurality of masked tokens, the plurality of motion tokens, and the plurality of text-based tokens, decoding the plurality of predicted motion tokens and the plurality of motion tokens into a motion sequence of the character, where the motion sequence includes the one or more motions and a predicted motion of the character, and controlling the character in the virtual environment based on the motion sequence.

In one or more variations of the system of the above paragraph, which may be implemented alone or in any combination: the instructions for performing the masked transformer routine further include: generating a first predicted value of each of the plurality of masked tokens, determining a first confidence score associated with the first predicted value of each of the plurality of masked tokens, and converting a first set of the plurality of masked tokens having the first confidence score that is greater than or equal to a first threshold confidence score to the plurality of predicted motion tokens; the instructions for performing the masked transformer routine further include: masking, based on a mask scheduling routine and using the first set of the plurality of masked tokens as an input condition, a subset of a second set of the plurality of masked tokens having the first confidence score that is less than the second threshold confidence score, generating, based on a stochastic sampling routine, one or more second predicted values associated with the subset of the second set of the plurality of masked tokens and one or more second confidence scores that are respectively associated with the one or more second predicted values, and converting at least a portion of the subset of the second set of the plurality of masked tokens having a second confidence score of the one or more second confidence scores that is greater than or equal to the second threshold confidence score to the plurality of predicted motion tokens; the stochastic sampling routine is a temperature sampling routine, a top-k sampling routine, or a top-p sampling routine; the mask scheduling routine is a cosine function, a linear function, or a square root function; the second threshold confidence score is less than the first threshold confidence score; the one or more motions includes a first motion and a second motion, where the predicted motion is between the first motion and the second motion; the one or more motions includes a first motion, where the predicted motion is between a first portion of the first motion and a second portion of the first motion; and/or the text input indicates a lower-body motion of the character and an upper-body motion of the character, the plurality of motion tokens comprise a plurality of lower-body motion tokens and a plurality of upper-body motion tokens, the instructions for appending the plurality of masked tokens to the plurality of motion tokens further comprise appending the plurality of masked tokens to the plurality of lower-body motion tokens, the plurality of predicted motion tokens are a plurality of predicted lower-body motion tokens that are generated based on the plurality of masked tokens, the plurality of lower-body motion tokens, and the plurality of text-based tokens, the instructions further comprise concatenating the plurality of lower-body motion tokens, the plurality of predicted lower-body motion tokens, and the plurality of upper-body motion tokens into a sequence of motion tokens, and/or the instructions for decoding the plurality of predicted motion tokens and the plurality of motion tokens into the motion sequence of the character further comprise decoding the sequence of motion tokens into the motion sequence of the character.

A system for training a masked transformer system configured to control a character in a virtual environment includes at least one processor and at least one nontransitory computer-readable medium comprising instructions that are executable by the at least one processor. The instructions include training a variational autoencoder to generate a plurality of motion tokens based on text inputs, appending a plurality of text-based tokens to the plurality of motion tokens, replacing a set of the plurality of motion tokens with a plurality of masked tokens, performing, by a masked transformer including one or more attention layers, a masked transformer routine to generate a plurality of reconstructed motion tokens based on the plurality of masked tokens, the plurality of motion tokens, and the plurality of text-based tokens, and selectively modifying one or more parameters of the one or more attention layers based on a difference between the plurality of motion tokens and the plurality of reconstructed motion tokens.

In one or more variations of the system of the above paragraph, which may be implemented alone or in any combination: the variational autoencoder is a vector quantized variational autoencoder that is trained based on a motion codebook including a plurality of reference codes; the instructions for training the vector quantized variational autoencoder to generate the plurality of motion tokens based on the text inputs indicating the one or more desired motions of the character further include: encoding the plurality of training text inputs into the plurality of motion tokens based on at least one reference code of the plurality of reference codes, where the plurality of motion tokens are a latent space representation of the desired motion of the character, decoding the plurality of motion tokens to generate reconstructed training text, and selectively modifying one or more parameters of the variational autoencoder based on a difference between the reconstructed training text and the plurality of text inputs; the difference between the plurality of motion tokens and the plurality of reconstructed motion tokens is further based on a reconstruction probability generated by the masked transformer or a reconstruction confidence value generated by the masked transformer; and/or the one or more attention layers include one or more self-attention layers and a cross-attention layer.

A method for controlling a character in a virtual environment includes executing, by at least one processor, computer program instructions stored in a non-transitory computer-readable storage medium to perform operations comprising: receiving a text input indicating one or more motions of the character, generating, based on the text input, a plurality of text-based tokens and a plurality of motion tokens, performing a masked transformer routine to generate a plurality of predicted motion tokens based on a plurality of masked tokens, the plurality of motion tokens, and the plurality of text-based tokens, decoding the plurality of predicted motion tokens and the plurality of motion tokens into a motion sequence of the character, where the motion sequence includes the one or more motions and a predicted motion of the character, and controlling the character in the virtual environment based on the motion sequence.

### BRIEF DESCRIPTION OF THE DRAWINGS

In order that the disclosure may be well understood, there will now be described various forms thereof, given by way of example, reference being made to the accompanying drawings, in which:

FIG. 1A is a functional block diagram of an example computing device and masked motion model system according to some embodiments of the present disclosure;

FIG. 1B schematically illustrates a character moving in a virtual environment according to some embodiments of the present disclosure;

FIG. 2A is a functional block diagram of an example motion tokenizer module of a motion model system according to some embodiments of the present disclosure;

FIG. 2B is a flowchart illustrating a method for training a motion tokenizer module of a motion model system according to some embodiments of the present disclosure;

FIG. 3A is a functional block diagram of a conditional masked motion module according to some embodiments of the present disclosure;

FIG. 3B schematically illustrates multiple iterations of a masked transformer routine that is performed by a conditional masked motion module to generate a plurality of predicted motion tokens according to some embodiments of the present disclosure;

FIG. 3C graphically illustrates multiple iterations of a masked transformer routine that is performed by a conditional masked motion module to generate a plurality of predicted motion tokens according to some embodiments of the present disclosure;

FIG. 3D is a flowchart illustrating a method for training a motion tokenizer module of a motion model system according to some embodiments of the present disclosure;

FIG. 4 illustrates a masked transformer routine that generates a plurality of predicted motion tokens interposed between one sequence of motion tokens and the corresponding movement of the character in the virtual environment to some embodiments of the present disclosure;

FIG. 5 illustrates a masked transformer routine that generates a plurality of predicted motion tokens interposed between a plurality of separate sequences of motion tokens and the corresponding movement of the character in the virtual environment to some embodiments of the present disclosure;

FIG. 6 is a flowchart illustrating a method for controlling a character in a virtual environment according to some embodiments of the present disclosure;

FIG. 7 is a functional block diagram of another example computing device and masked motion model system according to some embodiments of the present disclosure;

FIG. 8 illustrates a masked transformer routine performed by the masked motion model system of FIG. 7 to selectively edit upper and/or lower body motions of the character in the virtual environment according to some embodiments of the present disclosure; and

FIG. 9 is a flowchart illustrating a method for controlling a character in a virtual environment according to some embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In this application, the term module may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as, but not limited to, transceivers, routers, input/output interface hardware, among others; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media, and optical storage media. The term code, as used herein, may include software, firmware, and/or microcode, and may refer to computer programs, routines, functions, classes, data structures, and/or objects.

The performance characteristics, fidelity, and editability of the language-motion latent space alignment routines, conditional diffusion model routines, and/or conditional autoregressive model routines may be inhibited by various model-based constraints. As an example, when performing language-motion latent space alignment routines (e.g., Language2Pose, TEMOS, T2M, MotionCLIP, TMR and DropTriple), text descriptions and motion sequences are projected into separate latent spaces and are aligned by imposing distance loss functions, such as cosine similarity, Kullback-Leibler (KL) divergences, and contrastive losses. Due to the significant variations between text and motion distributions, it may be difficult to accurately and efficiently align the separate latent spaces in a manner that enables high-fidelity motion generation.

As another example, a conditional diffusion model (e.g., MDM, MotionDiffuse, or FRAME) is trained to generate a probabilistic mapping based on the textural descriptors associated with the motion sequences. That is, the conditional diffusion model is trained to accurately map text to motion (and/or edit motion sequences) by applying diffusion processes onto low-dimensional motion latent space representations of raw and redundant motion sequences. While raw motion sequences enable the use of semantic motion editing (e.g., body part editing of the virtual character) due to the partial denoising functions that can be performed on certain motion frames and/or portions of the virtual character, the redundancy of the motion sequences requires substantial computing resources and time to generate the motion sequences. For example, the average inference time per sentence (AITS) of the MDM and MotionDiffuse may be 28.11 seconds and 10.071 seconds, respectively. In some embodiments, to improve the speed and/or reduce the amount of required computational resources, the conditional diffusion model may compress raw motion data into a single latent embedding prior to applying the diffusion processes. However, compressing the raw motion data may conceal various temporal-spatial semantics present in the raw motion data, thereby making it difficult to accurately and efficiently edit the motion sequences. For example, the MDM and MotionDiffuse models may have a motion generation quality score (FID score) of 0.544 and 0.630, where scores that are closer to zero are associated with increased accuracy, and scores that are closer to one are associated with decreased accuracy.

As yet another example, an autoregressive model (e.g., T2M-GPT, AttT2M, or MotionGPT) is trained to model temporal correlations within motion sequences and, more specifically, to predict and generate the next motion token conditioned on the text token and previously generated motion tokens. While the autoregressive models generally have improved computational speeds (e.g., lower AITS, such as between about 0.22 and 0.53 seconds) and motion fidelity relative to conditional diffusion models (e.g., a FID score of approximately 0.11), the autoregressive decoding process utilizes causal attention for unidirectional and sequential motion token prediction. As such, the autoregressive decoding process may inhibit the model's ability to identify bidirectional (or omnidirectional) dependencies in motion data, may increase the training and inference time, and may inhibit the editability of the motion sequences.

According to embodiments of the present disclosure, a masked motion model (MMM) system for controlling a character in a virtual environment is disclosed. The MMM system includes a motion tokenizer (MT) module that transforms human motion into a sequence of discrete tokens (e.g., discrete units, elements, and/or character strings that represent segments of the input data) in a latent space and a conditional masked motion transformer (CMMT) module that predicts randomly masked motion tokens, which are conditioned on the discrete tokens generated by the MT module. The MMM system described herein is configured to decode the discrete tokens in an omnidirectional manner (e.g., all directions) to identify inherent dependencies among the discrete tokens and semantic mapping between the discrete tokens. Accordingly, the MMM system may iteratively decode several discrete tokens in parallel while considering context from both preceding and succeeding tokens to generate high-fidelity motion (e.g., a FID score of approximately 0.089 or less) with substantially reduced amounts of computing resources and time (e.g., an AITS of 0.081 seconds). Additionally, the MMM system accurately edits motion (e.g., body part modification) by embedding masked tokens within the discrete tokens and iteratively unmasking said masked tokens, thereby providing smooth transitions between edited and non-edited portions of the motion sequence.

According to embodiments of the present disclosure, the MMM system is trained based on a two-stage approach. In the first stage, the MT module is trained to convert and quantize raw motion data into a sequence of discrete motion tokens in the latent space based on a motion codebook. In the second stage, motion tokens generated by the MT module are randomly masked, and the parameters of the CMMT module are iteratively and selectively modified until the CMMT can accurately predict the masked tokens based on the unmasked tokens and an input text.

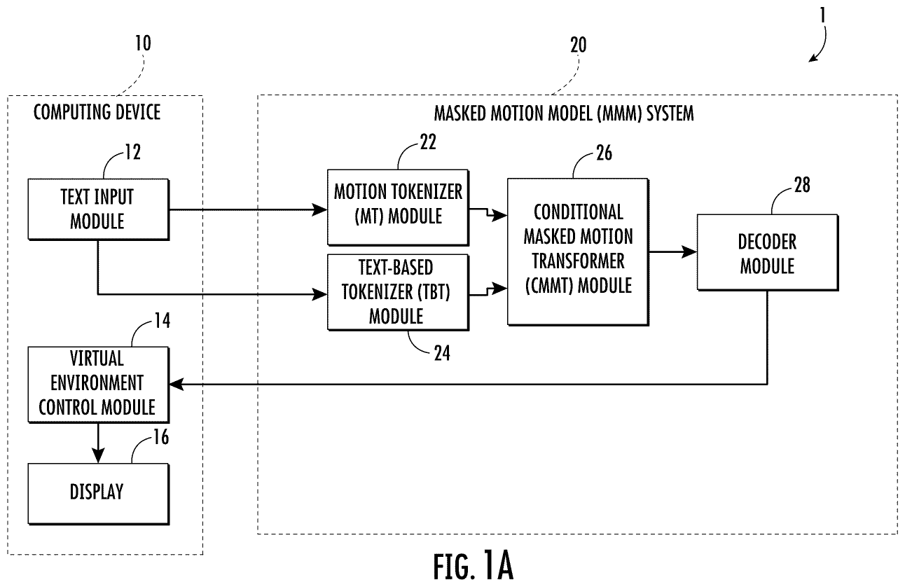

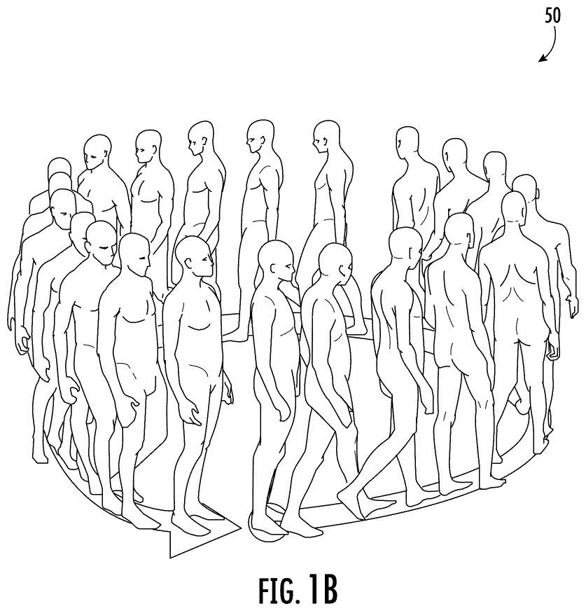

Referring to FIG. 1A, a system 1 is provided and generally includes a computing device 10 and an MMM system 20. It should be readily understood that any one of the components of the system 1 can be provided at the same location or distributed at different locations (e.g., via one or more edge computing devices) and coupled accordingly. In some embodiments, the components of the system 1 are communicably coupled using known wired and/or wireless communication protocols.

In some embodiments, the computing device 10 includes a text input module 12, a virtual environment control module 14, and a display 16. The text input module 12 may be a device that is configured to receive and transmit one or text inputs to the MMM system 20 based on a received input. As an example, the text input module 12 may receive and transmit text inputs from a keyboard of the computing device 10, from the display 16, and/or from any other type of device that is configured to provide text inputs to the text input module 12. In some embodiments, the text input may indicate one or more desired motions of a character generated by the virtual environment control module 14, as described below in further detail. The display 16 may be any type of display device, such as a liquid crystal display (LCD) device, a light emitting diode (LED) display, an organic light emitting diode (OLED) display, a quantum dot light emitting diode (QLED) display, and/or a touchscreen device (e.g., a capacitive touchscreen device or a resistive touchscreen device).

Referring to FIGS. 1A-1B, the virtual environment control module 14 and the display 16 are collectively configured to generate and display a virtual environment 50 by performing known virtual environment modeling, mapping, simulation, and display routines. As used herein, “virtual environment” refers to a two-dimensional (2D) and/or three-dimensional (3D) digital representation of an environment (e.g., an actual/physical environment or a simulated environment) and/or an object thereof, such as a character and/or other types of objects. In some embodiments, the character of the virtual environment is a humanoid that represents a human or a robot, but it should be understood that the virtual environment may include any types of characters in other embodiments (e.g., an animal-based character). In some embodiments, the virtual environment control module 14 is configured to control a movement of the one or more characters in the virtual environment based on a command received from the MMM system 20 indicating a motion sequence of the one or more characters, as described below in further detail.

In some embodiments, the MMM system 20 may include a motion tokenizer (MT) module 22, a text-based tokenizer (TBT) module 24, a conditional masked motion transformer (CMMT) module 26, and a decoder module 28.

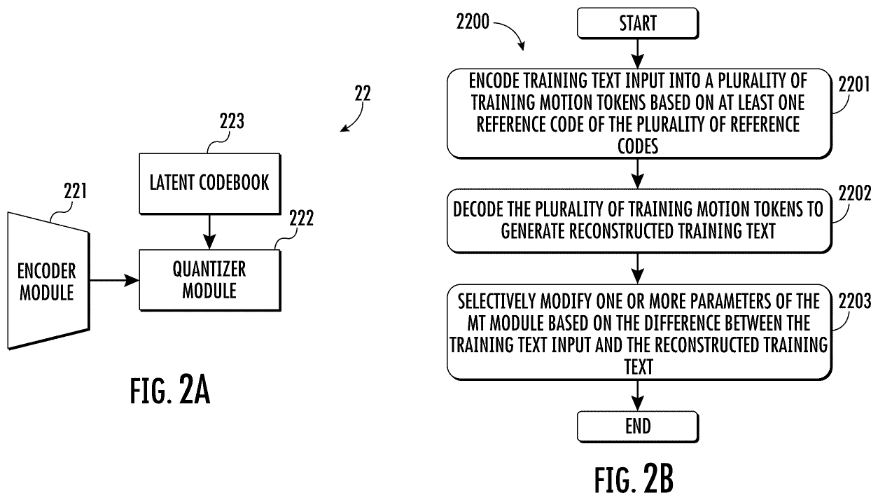

The MT module 22 is configured to generate a plurality of motion tokens based on a text input (e.g., one or more desired motions of the character) received from the text input module 12. In some embodiments, the plurality of motion tokens are latent space representations (e.g., a reduced/compressed representation, such as an n-dimensional latent vector, where n is greater than 1) of one or more desired motions of the character. In some embodiments and referring to FIGS. 1A and 2A, the MT module 22 may be a variational autoencoder (e.g., a vector quantized variational autoencoder (VQ-VAE)) including an encoder module 221, a quantizer module 222, and a latent codebook 223.

The encoder module 221 is configured to perform known encoding routines to encode the text input into a n-dimensional latent representation (e.g., an n-dimensional latent vector). The quantizer module 222 is configured to map the n-dimensional latent representation to a target reference code of a plurality of reference codes (or embedding vectors) stored in the latent codebook 223 and converts the n-dimensional latent representation to a quantized n-dimensional latent representation based on the target reference code. As used herein, the “reference codes” refer to predefined latent space representations (e.g., latent vectors) of predefined motions of the character in the virtual environment, and the “target reference code” refers to a reference code having a highest degree of matching or similarity with the n-dimensional latent representation generated by the encoder module 221. In some embodiments, the number of reference codes and the number of dimensions may be selected to reduce information loss and to inhibit codebook collapse (e.g., the majority of n-dimensional representations matching a small number reference codes). As an example, the number of reference codes may be 512, 1024, 2048, 4096, and 8192, and the number of dimensions, which may be implemented with any one of the number of reference codes, may be 512, 256, 128, 64, 32. As a specific example, the number of reference codes may be 8192, and each reference code may be a 32-dimensional latent vector.

In some embodiments, the quantizer module 222 and the latent codebook 223 employ a codebook factorization schema (e.g., where the plurality of reference codes and the n-dimensional representation generated by encoder module 221 have different dimensionalities) to improve the accuracy of the motion tokens generated by the MT module 22. As an example, the plurality of reference codes of the latent codebook 223 may be configured to have an m-dimensional latent space representation (where m is less than n) to enable code matching in a lower-dimensional latent space.

In some embodiments and referring to FIGS. 1A and 2A-2B, the MT module 22 may be pretrained or trained to accurately generate a plurality of motion tokens based on training text inputs indicating one or more sample motions of the character. For example, during a training routine illustrated by flowchart 2200, the encoder module 221 may encode, based on the latent codebook 223, several different training text inputs into a plurality of training motion tokens indicating sample character motions (step 2201). Furthermore, the quantizer module 222 may match the generated tokens to one of the plurality of reference codes of the latent codebook 223, and the decoder module 28 may decode the training motion tokens into reconstructed training text (step 2202). Thereafter, the training routine may include selectively modifying one or more parameters of the MT module 22 (e.g., architectural parameters and/or hyperparameters of the MT module 22) based on a difference between the training text inputs and the reconstructed training text (step 2203). That is, the architectural parameters (e.g., the number of layers, the types of layers, and/or the number of neurons in each layer) and/or hyper parameters (e.g., loss function parameters) may be iteratively modified until the difference is within an acceptable tolerance and/or deviation.

As an example, the training routine may be defined by an objective function that learns a discrete latent space by quantizing the encoder module 221 outputs z into the plurality of reference codes of the latent codebook 223. Specifically, the objective function L_{VQ} may be defined based on relation (1) below:

$${L}_{V Q} = {‖ sg ( z ) - e ‖}_{2}^{2} + β {‖ Z - s g ( e ) ‖}_{2}^{2} \qquad ( 1 )$$

In relation (1), sg(⋅) refers to a stop-gradient operator, β refers to a hyper-parameter for a commitment loss, and e is a reference code from the latent codebook 223 E (e∈E). In some embodiments, the closest or smallest Euclidean distance of the output of the encoder module 221 z and the reference code e is determined based on relation (2) below.

$$i = arg {min}_{j} {‖ z - {E}_{j} ‖}_{2}^{2} \qquad ( 2 )$$

In some embodiments, training the MT module 22 may further include periodically performing a codebook resetting and updating routine (e.g., after each training iteration, every 20 training iterations, every 40 iterations, every 60 iterations, every 80 iterations, etc.) to inhibit codebook collapse, where the majority of tokens are allocated to a small set of codes. The codebook resetting and updating routine may include identifying unused reference codes in the latent codebook 223, resetting the embeddings of the unused reference codes, and reinitializing (e.g., randomly reinitializing or reinitializing based on a moving average) the reset unused reference codes.

Referring to FIG. 1A, the TBT module 24 is configured to generate a plurality of text-based tokens based on the text input. In some embodiments, the TBT module is a text encoder (e.g., a contrastive language image pretraining (CLIP) text encoder, a byte-pair encoding tokenizer, and/or a bidirectional encoder transformer (BERT)) that generates text-based tokens, such as sentence tokens (e.g., tokens that correspond to the entirety of the text input and/or distinct sentences of the text input) and/or word tokens (e.g., tokens that correspond to each word or subword of the text input) that identify semantic meanings of the text input. The TBT module 24 may be trained by known text encoder training routines.

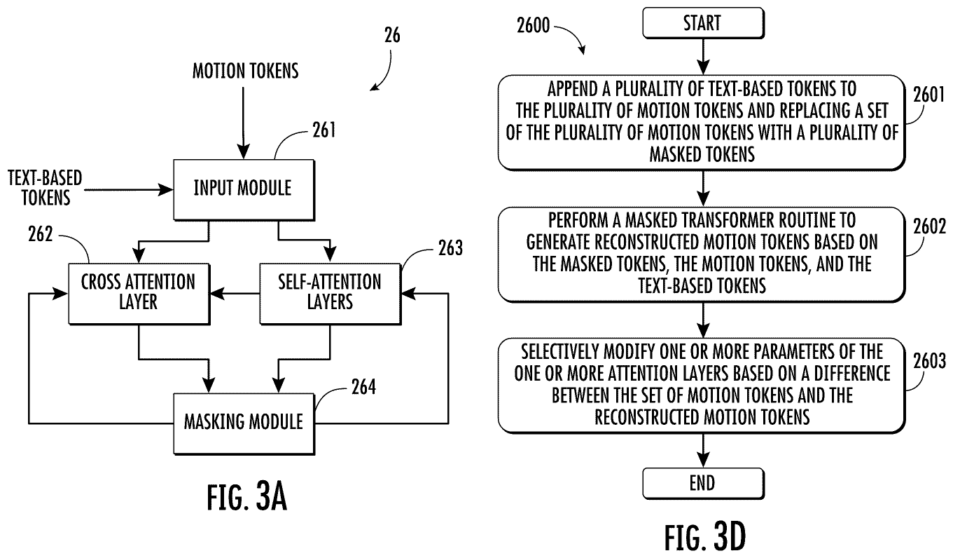

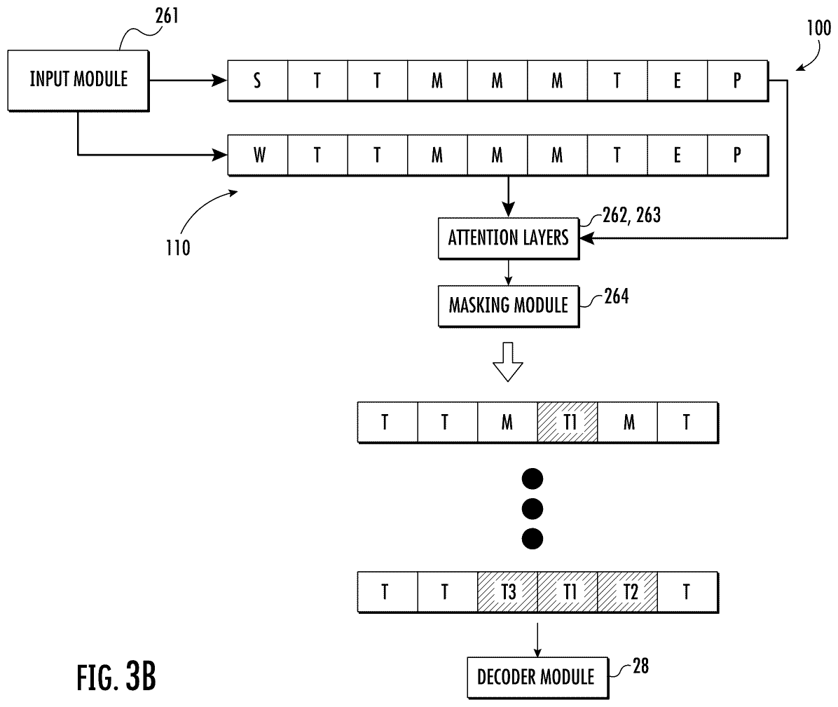

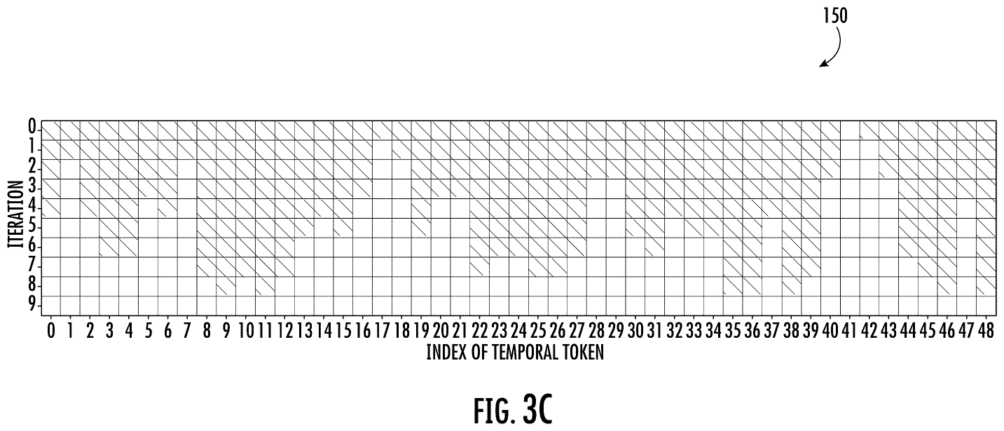

The CMMT module 26 is configured to generate a plurality of predicted motion tokens by performing a masked transformer routine based on a plurality of masked tokens, the plurality of motion tokens generated by the MT module 22, and the plurality of text-based tokens generated by the TBT module 24. The plurality of predicted motion tokens may correspond to latent space representations of the output of the masked transformer routine. In some embodiments and referring to FIGS. 1A and 3A, the CMMT module 26 may include an input module 261, self-attention layers 262, a cross attention layer 263, and a masking module 264. While only one cross attention layer 262 is shown, it should be understood that the CMMT module 26 may include multiple cross attention layers 262 in some embodiments.

The input module 261 is configured to append pad tokens, an end token (e.g., a token that indicates an endpoint of a motion sequence), the text-based tokens generated by the TBT module 24 (e.g., the sentence token and/or the word token), and/or a plurality of masked tokens to the plurality motion tokens, which may be collectively referred to hereinafter as “the input tokens.” The CMMT module 26 may append the pad tokens to the plurality of motion tokens when the length of the motion tokens is less than a threshold value, thereby allowing the computation of batches with multiple motion sequences of varying input text lengths and/or token lengths. The CMMT module 26 may append the plurality of masked tokens at various locations, such as between the sentence token and the end token, between the text-based token and the plurality of motion tokens, between the end token and the plurality of motion tokens, and/or between one or more pairs of the plurality of motion tokens. As used herein, the “masked tokens” refer to placeholder tokens that initially have a null value and are replaced with a predicted value based on the masked transformer routine performed by the masking module 264, which is described below in further detail. The number of masked tokens that are appended to the motion tokens may be determined based on a masked scheduling routine, which is described below in further detail.

As an example and referring to FIG. 3B, the input module 261 is configured to generate input tokens 100 by appending the sentence token(S) before the first motion token (T), appending an end token (E) after the last motion token (T), appending a pad token (P) after the end token (E), and appending three masked tokens (M) between a pair of the motion tokens (T). Additionally, the input module 261 is configured to generate input tokens 110 by appending the word token (W) before the first motion token (T), appending an end token (E) after the last motion token (T), appending pad token (P) after the end token (E), and appending three masked tokens (M) between a pair of the motion tokens (T). In some embodiments, the masked tokens (M) are appended to temporal locations in which transitions between first and second motions are desired, or to temporal locations in which edits to a single motion are desired. It should be understood that the input tokens 100, 110 may have varying lengths, numbers of pad tokens, motion tokens, and/or masked tokens in other embodiments and is not limited to the example described herein.

The self-attention layers 262 are configured to capture different relationships among the input tokens 100 by generating attention scores associated with a set of the input tokens 100 (e.g., the sentence token(S), the motion tokens (T), and the masked tokens (M)). The self-attention layers 262 are configured to perform a SoftMax routine to normalize the attention scores into a probability distribution and output a weighted sum for each token of the set input tokens 100 to capture the relationships and dependencies associated with the set of input tokens 100.

The cross attention layer 263 is configured to capture different relationships among the input tokens 110 by generating attention scores associated with a set of the input tokens 110 (e.g., the word token (W), the motion tokens (T), and the masked tokens (M)) and encoded outputs of the self-attention layers 262. The cross attention layer 263 is configured to perform a SoftMax routine to normalize the attention scores into a probability distribution and output a weighted sum capture the relationships and dependencies associated with the set of input tokens 110 and the encoded outputs of the self-attention layers 262. As an example, the relationships may be determined by a SoftMax routine based on the key vectors of each of the (T) total word tokens (K_{word}), the query vector of the motion tokens (Qₘₒₜᵢₒₙ), the value vector of the word token (V_{word}), and the dimensionality of the motion tokens and word tokens (D), as shown below by relation (3).

$$cross attention = softmax ( \frac{{Q}_{m o t i o n} {K}_{w o r d}^{T}}{\sqrt{D}} ) {V}_{w o r d} \qquad ( 3 )$$

The masking module 264 is configured to perform a masked transformer routine to generate a plurality of predicted motion tokens based on a set of the input tokens (e.g., the plurality of masked tokens, the plurality of motion tokens, and the plurality of text-based tokens) and the outputs of the attention layers 262, 263. Specifically, the masked transformer routine may convert the masked tokens (M) into the plurality of predicted motion tokens (t1, t2, t3). In some embodiments, the masked transformer routine includes generating a first predicted value of each of the plurality of masked tokens (M), determining a confidence score of the first predicted values, masking a first set of the masked tokens having the first confidence score that is less than a first threshold confidence score, and converting a second set of the masked tokens having the first confidence score that is greater than or equal to the first threshold confidence score to the plurality of predicted motion tokens.

As an example, the masking module 264 may include a classification layer (e.g., a dense layer and a SoftMax layer) that generates the first predicted values of each of the plurality of masked tokens (M) during a first iteration of the masked transformer routine based on the plurality of motion tokens and the text-based tokens. As an example and referring to FIG. 3C, first predicted values (not shown) are generated for each of the 49 masked tokens during a first iteration of the masked transformer routine.

Subsequently, the classification layer of the masking module 264 may determine a first confidence score associated with the first predicted value of each of the plurality of masked tokens (M). A first set of masked tokens having confidence scores that are greater than or equal to a first threshold confidence score are converted to predicted motion tokens (e.g., masked token 41 in FIG. 3C). A second set of the masked tokens having a confidence score in the first iteration that are less than the first threshold confidence score (e.g., masked tokens 0-40 and 42-48 in FIG. 3C) are selectively masked in a second iteration of the masked transformer routine using the first set of masked tokens as input conditions, as described below in further detail.

During the second iteration of the masked transformer routine, the masking module 264 may re-mask, based on a mask scheduling routine and using the first set of masked tokens as an input condition, at least a portion of the second set of masked tokens (e.g., a subset of the second set of masked tokens) having the first confidence score that is less than the first threshold confidence score (e.g., masked tokens 0-40 and 42-48 in FIG. 3C). In some embodiments, the mask scheduling routine is configured to determine the number of the subset of the second set of masked tokens to be re-masked. As an example, the number of the subset of the second set of masked tokens may be less than or equal to the number of the second set of masked tokens. Furthermore, the number of masked tokens that are re-masked in the second iteration of the masked transformer routine may be less than the number of masked tokens that are re-masked in a third and subsequent iterations due to a decaying ratio of the masked transformer routine. Example mask scheduling routines include, but are not limited to, a cosine function (e.g., a function that represents a concave dependency between a length of the potential masked tokens to be re-masked, the initial and final decaying ratios, and the iteration number), a linear function (e.g., a function that represents an inverse relationship between a length of the potential masked tokens to be re-masked the initial and final decaying ratios, and the iteration number), or a square root function (e.g., a function that represents a convex dependency between a length of the potential masked tokens to be re-masked, the initial and final decaying ratios, and the iteration number).

During the second iteration and when the second set of masked tokens are re-masked in accordance with the masked scheduling routine described above, the masking module 264 may generate a second predicted value and an associated second confidence score of each of the subset of the second set of masked tokens based on a stochastic sampling routine, which samples the masked tokens based on their confidence scores. Example stochastic sampling routines include, but are not limited to, a temperature sampling routine, a top-k sampling routine, or a top-p sampling routine. In some embodiments, the temperature sampling routine samples the masked tokens (M) based on a SoftMax distribution function that is shaped by a temperature parameter β, as shown below by relation (4).

$$p ( {y}_{i} \vert {Y}_{\hat{M}} , W ) = \frac{exp ( {e}_{i} β )}{{\sum }_{i ∈ E} exp ( {e}_{i} β )} \qquad ( 4 )$$

In relation (4), eᵢ corresponds to logits for reference codes yᵢ from the latent codebook, and E corresponds to the latent codebook 223. Lower temperature values assign more weight to masked tokens with higher prediction confidences, and higher temperature values are associated with sampling the masked tokens with relatively equal probabilities. In some embodiments, top-k sampling routines are configured to sample the masked tokens from the top k most probable choices (where k is an integer). As an example, the top-k sampling routine identifies the top k codebook entries of the latent codebook 223 and forms a new codebook including the k codebook entries (E^{k}∈E), which maximizes the original distribution (Σ_{i∈E}_{^{k}}p(yᵢ|Y_{\hat{M}}, W)). Subsequently, the original distribution is rescaled to a new distribution, from which the masked tokens are sampled. In some embodiments, top-p sampling routines (e.g., nucleus sampling routines) are configured to sample the highest probability masked tokens whose cumulative probability mass exceeds a predetermined threshold value p (where 0≤p≤1). As an example, the top-p sampling routine identifies the top p codebook of the latent codebook 223 (E^{p}∈E) such that it satisfies the original distribution (Σ_{i∈E}_{^{k}}p(yᵢ|Y_{\hat{M}}, W)>p). Subsequently, the original distribution is rescaled to a new distribution, from which the masked tokens are sampled.

During the second iteration and when the second confidence scores of the subset of the second set of masked tokens are determined, the masking module 264 may convert a portion of the subset of the second set of masked tokens having a second confidence score that is greater than or equal to a second threshold confidence score to the predicted motion tokens (e.g., masked token 42 in FIG. 3C). In some embodiments, the first and second threshold confidence scores are different (e.g., the second threshold confidence score is less than the first threshold confidence score due to the masking ratio that gradually decreases the threshold as the number of training iterations increase). Additional iterations of the masked transformer routine may be performed that are similar to the second iteration until each of the masked tokens are converted into the predicted motion tokens (e.g., nine total iterations of the masked transformer routine are performed to convert the 49 masked tokens into 49 predicted motion tokens in FIG. 3C, or three total iterations of the masked transformer routine are performed to convert the three masked tokens (M) in FIG. 3B into the predicted motion tokens t1, t2, t3).

In some embodiments and referring to FIGS. 3A and 3D, the CMMT module 26 may be pretrained or trained based on a training routine. The training of the CMMT module 26 may be performed in conjunction with or separately from the training of the MT module 22 described above (e.g., the training routine illustrated by flowchart 2200). In some embodiments, the training routine may include appending masked tokens to randomly replace a set of the motion tokens and selectively modifying parameters of the attention layers 262, 263 to thereby train the CMMT module 26 to accurately reconstruct the replaced motion tokens.

As an example, during training routine illustrated by flowchart 2600 in FIG. 3D, the CMMT 26 may append a plurality of text-based tokens to a plurality of motion tokens generated by the MT module 22 and replaces a set of the motion tokens with a plurality of masked tokens (step 2601). The CMMT module 26 then performs the masked transformer routines described herein to convert, based on the masked tokens, the motion tokens, and the text-based tokens, the masked tokens into a plurality of reconstructed motion tokens (step 2602). The CMMT module 26 then selectively modifies one or more parameters of the one or more attention layers 262, 263 based a difference between the set of motion tokens (i.e., the set of replaced motion tokens) and the reconstructed motion tokens (step 2603).

In some embodiments, the difference between the set of motion tokens and the reconstructed motion tokens is represented as a reconstruction probability and/or confidence value (e.g., p(yᵢ|Y_{\hat{M}}, W) shown below in relation (5)) that is generated by the CMMT 26. As an example, the difference may be represented by an objective function that inhibits the negative log-likelihood of the predicted masked tokens conditioned on the text ( [symbol] ₘₐₛₖ), as described below in relation (5):

$${ℒ}_{m a s k} = - \begin{matrix}E \\ Y ∈ D\end{matrix} [ {\sum }_{∀ i ∈ [ 1 , L ]} log p ( {y}_{i} \vert {Y}_{\hat{M}} , W ) ] \qquad ( 5 )$$

In relation (5), Y denotes the motion sequence, W denotes the sentence tokens, L denotes the length of the token sequence including the text-based tokens, the motion tokens, p denotes the probability value, and D denotes the word tokens.

Referring to FIG. 1A, the decoder module 28 is configured to decode the plurality of predicted motion tokens and the plurality of motion tokens (collectively referred to as “output tokens”) generated by the CMMT module 26 into a motion sequence of the character (e.g., a predicted motion and one or more motions of the character). In some embodiments, the decoder module 28 decodes the output tokens into character control instructions that are interpretable and executable by the virtual environment control module 14 and transmits the character control instructions to the virtual environment control module 14. In response to receiving the character control instructions, the virtual environment control module 14 is configured to control the movement of the character in the virtual environment 50 shown in FIG. 1B such that the movement corresponds to the text received by the text input module 12.

Accordingly, the MMM system 20 described herein is configured to transform character motions (e.g., 3D human motions) into a sequence of discrete tokens in latent space and predict randomly masked motion tokens that are condition on text-based tokens. That is, by attending to motion and text-based tokens in an omnidirectional manner, the MMM system 20 captures inherent dependencies among motion tokens and semantic mappings between motion tokens and text-based tokens. Moreover, during inference, the MMM system 20 iteratively decodes several motion tokens in parallel that are consistent with granular input text descriptions and thus achieve both high-fidelity and high-speed motion generation.

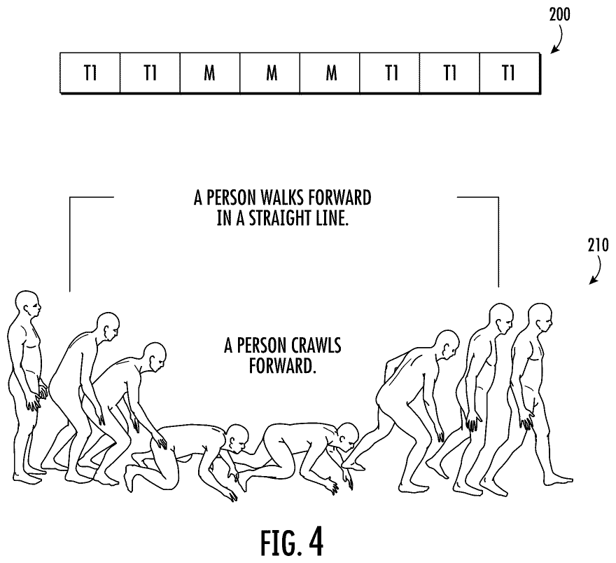

In addition, the MMM system 20 described herein is configured to edit single motion sequences with high-fidelity and with reduced time and computational resources. As an example and referring to FIG. 4, a sequence of tokens 200 may include first motion tokens T1, which may correspond to “a person walks forward in a straight line,” and masked tokens M that replace a set of the first motion tokens T1 in which editing of the corresponding portion of the character motion 210 is desired. As described herein, the MMM system 20 iteratively performs the masked routine to generate predicted values of the masked tokens M (e.g., “a person that crawls forward”) that are conditioned on the text-based tokens (not shown) and the first motion tokens T1 to edit the motion in a smooth, continuous manner without any further or separate training of the MMM system 20 that accounts for motion editing.

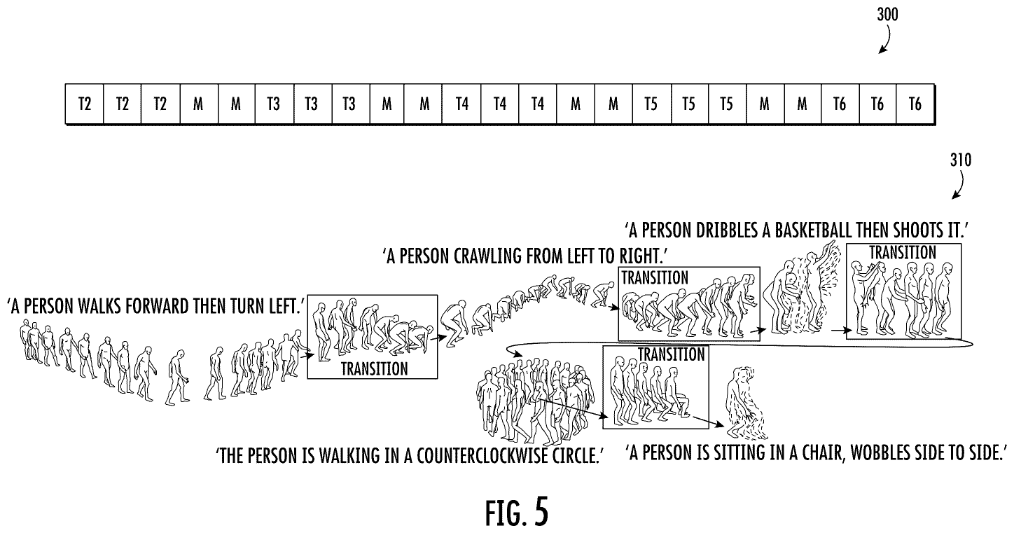

Furthermore, the MMM system 20 described herein is configured to generate substantially longer motion sequences (e.g., substantially greater than ten seconds) than conventional text-to-motion systems (e.g., HumanML3D and KIT). As an example and referring to FIG. 5, a sequence of tokens 300 may include motion tokens T2 (“e.g., a person walks forward and turns left”), T3 (“e.g., a person crawling from left to right”), T4 (“e.g., a person dribbles a basketball then shoots it”), T5 (“e.g., a person is walking in a counterclockwise circle”), and T6 (“e.g., a person is sitting in a chair, wobbles side to side”) and masked tokens M (e.g., the “transitions” of FIG. 5) interposed therebetween that collectively represent character motion 310. While conventional diffusion models require multiple steps (e.g., 1000 steps) to generate transitions and average the spatial differences between two adjacent motions, the MMM system 20 described herein utilizes a single step (e.g., performing the masked transformer routine to generate the masked tokens between two adjacent sequences of motion tokens). As such, the MMM system 20 may generate longer character motion sequences with reduced the time and computational resources compared to conventional systems.

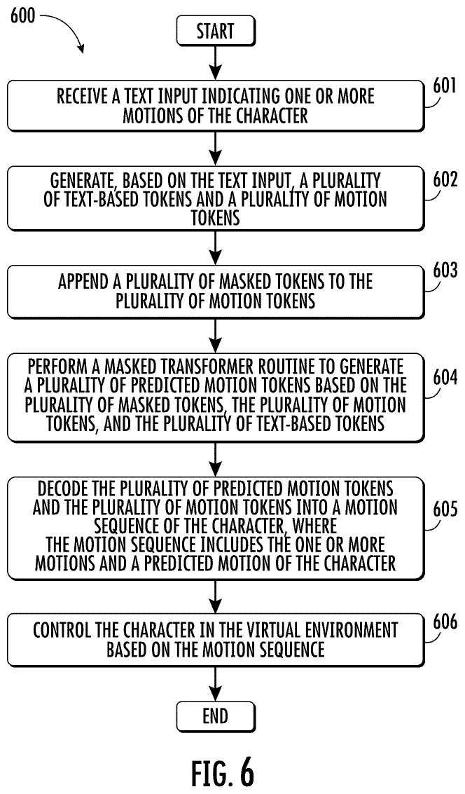

Referring to FIG. 6, a flowchart 600 illustrating a method for controlling a character in a virtual environment according to some embodiments of the present disclosure is shown. At step 601, the MMM system 20 receives a text input indicating one or more motions of the character. At step 602, the MMM system 20 generates, based on the text input, a plurality of text-based tokens and a plurality of motion tokens. At step 603, the MMM system 20 appends a plurality of masked tokens to the plurality of motion tokens. At step 604, the MMM system 20 performs a masked transformer routine to generate a plurality of predicted motion tokens based on the plurality of masked tokens, the plurality of motion tokens, and the plurality of text-based tokens. At step 605, the MMM system 20 decodes the plurality of predicted motion tokens and the plurality of motion tokens into a motion sequence of the character, where the motion sequence comprises the one or more motions and a predicted motion of the character. At step 606, the virtual environment control module 14 controls the character in the virtual environment based on the motion sequence.

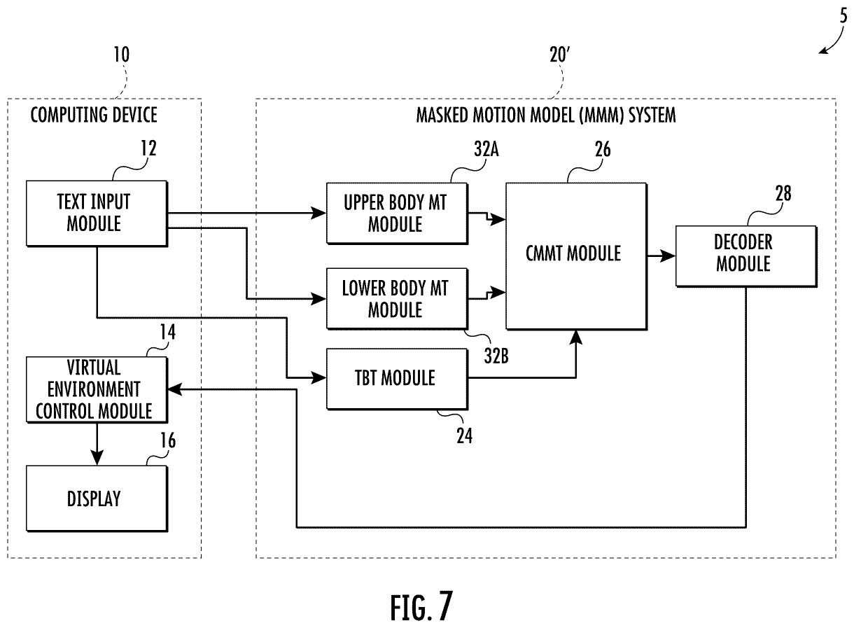

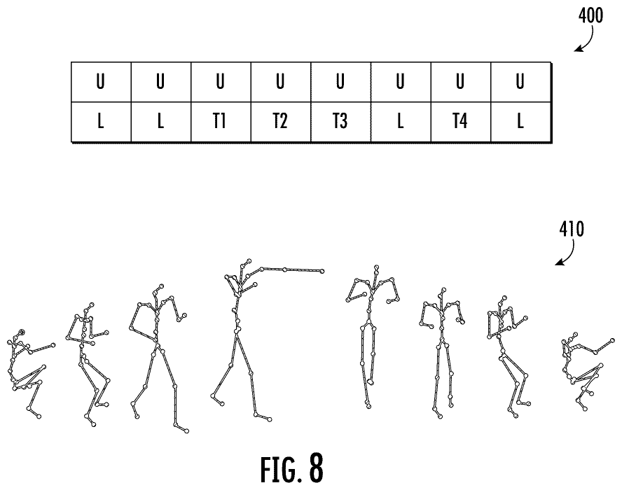

Referring to FIG. 7, a system 5 is provided and generally includes the computing device 10 and an MMM system 20′, which is similar to the MMM system 20 described above except that the MT module 22 is omitted. In some embodiments, the MMM system 20′ includes an upper body MT module 32A and a lower body MT module 32B. The upper body MT module 32A is similar to the MT module 22 except that it is configured to generate a plurality of upper-body motion tokens based on the text input received from the text input module 12. Similarly, the lower body MT module 32B is similar to the MT module 22 except that it is configured to generate a plurality of lower-body motion tokens based on the text input received from the text input module 12. As used herein, “lower-body motion” refers to motions of a lower portion of the character in the virtual environment, and “upper-body motion” refers to motions of an upper portion of the character in the virtual environment. In some embodiments, the lower-body and upper-body motions may collectively represent a full-body motion (or motion of an entirety of) the character, but it should be understood that the lower-body and upper-body motions may not collectively represent the full-body motion in other embodiments.

In some embodiments, the upper body MT module 32A and the lower body MT module 32B are configured to receive separate text inputs corresponding to one or more desired lower and upper body motions, respectively. In some embodiments, the upper body MT module 32A and the lower body MT module 32B further comprise a classification-based neural network or other similar neural network that is configured to perform known classification routines to parse the input text, differentiate portions thereof as lower and/or upper body motions, and transmit the identified lower and/or upper body motions to the respective upper body MT module 32A and/or the lower body MT module 32B.

In some embodiments, the CMMT module 26 is configured to append a plurality of masked tokens to the plurality of lower-body motion tokens, as described above with reference to FIGS. 1-6. Additionally, the CMMT module 26 is configured to perform the masked transformer routine to generate a plurality of predicted lower-body motion tokens based on the plurality of masked tokens, the plurality of lower-body motion tokens, and the plurality of text-based tokens in a similar manner described above with reference to FIGS. 1-6.

In some embodiments and referring to FIGS. 7-8, the CMMT module 26 is further configured to concatenate the plurality of lower-body motion tokens (L), the plurality of predicted lower-body motion tokens (T1, T2, T3, T4), and the plurality of upper-body motion tokens (U) into a sequence of motion tokens 400 that correspond to a full-body motion of the character. Subsequently, the decoder module 28 decodes the sequence of motion tokens 400 into a lower-body motion sequence and an upper-body motion sequence of the character in a similar manner described above with reference to FIGS. 1-6, and the virtual environment control module 14 controls the character in the virtual environment based on the lower-body motion sequence and the upper-body motion sequence, as illustrated by character motion 410.

In some embodiments, the upper body MT module 32A and the lower body MT module 32B may be trained separately in a similar manner described above with reference to FIGS. 2A-2B. Additionally, the CMMT module 26 may be trained in a similar manner described above with reference to FIGS. 2A-2B, except that random masked tokens are introduced into the lower-body motion tokens to enable the CMMT module 26 to learn the spatial and temporal dependency of the full-body motions. As an example, the training loss may correspond to relation (6) below:

$${ℒ}_{u p} = - \begin{matrix}E \\ Y ∈ D\end{matrix} [ {\sum }_{∀ i ∈ [ 1 , L ]} log p ( {y}_{i}^{up} \vert {Y}_{M}^{up} , {Y}_{M}^{down} , W ) ] \qquad ( 6 )$$

In relation (6), Y_{M}^{up} denotes the upper-body tokens and Y_{M}^{down} denotes the lower-body tokens. In some embodiments, the lower-body tokens may remain unchanged throughout all trained iterations so that the spatial and temporal dependencies of full-body motions are accurately learned.

In some embodiments, uncorrelated motions between upper and lower body motions and/or inaccurate full-body motions of the characters may be present when all (or none) of the lower-body motion tokens are masked. Accordingly, by conditioning the upper-body motion tokens on some of the lower-body motion tokens via the masked tokens, as described herein, the CMMT module 26 can generate accurate and realistic motion sequences of the character in the virtual environment.

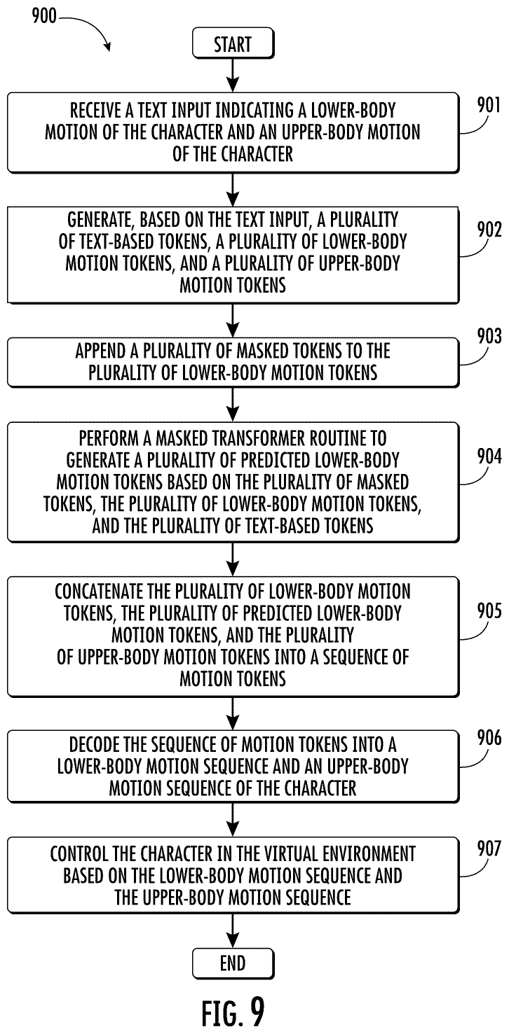

Referring to FIG. 9, flowchart 900 illustrating a method for controlling a character in a virtual environment according to some embodiments of the present disclosure. At step 901, the MMM system 20′ receives a text input indicating a lower-body motion of the character and an upper-body motion of the character. At step 902, the MMM system 20′ generates, based on the text input, a plurality of text-based tokens, a plurality of lower-body motion tokens, and a plurality of upper-body motion tokens. At step 903, the MMM system 20′ appends a plurality of masked tokens to the plurality of lower-body motion tokens. At step 904, the MMM system 20′ performs a masked transformer routine to generate a plurality of predicted lower-body motion tokens based on the plurality of masked tokens, the plurality of lower-body motion tokens, and the plurality of text-based tokens. At step 905, the MMM system 20′ concatenates the plurality of lower-body motion tokens, the plurality of predicted lower-body motion tokens, and the plurality of upper-body motion tokens into a sequence of motion tokens. At step 906, the MMM system 20′ decodes the sequence of motion tokens into a lower-body motion sequence and an upper-body motion sequence of the character. At step 907, the MMM system 20′ controls the character in the virtual environment based on the lower-body motion sequence and the upper-body motion sequence.

The terminology used in the description of the disclosure herein is for the purpose of describing particular embodiments only and is not intended to be limiting of the disclosure. As used in the description of the disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the phrase at least one of A, B, and C should be construed to mean a logical (A OR B OR C), using a non-exclusive logical OR, and should not be construed to mean “at least one of A, at least one of B, and at least one of C.”

The present disclosure has been described herein with reference to flowchart and/or block diagram illustrations of methods, systems, and devices in accordance with exemplary embodiments of the present disclosure. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create configured the machine to carry out the functions specified in the flowchart and/or block diagram block or blocks.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The present disclosure is described with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Thus, variations that do not depart from the substance of the disclosure are intended to be within the scope of the disclosure. Such variations are not to be regarded as a departure from the spirit and scope of the disclosure. The scope of the present disclosure is defined by the attached claims.

What is claimed is:

1. A system for controlling a character in a virtual environment, the system comprising:
at least one processor; and
at least one nontransitory computer-readable medium comprising instructions that are executable by the at least one processor, wherein the instructions comprise:
receiving a text input indicating one or more motions of the character;
generating, based on the text input, a plurality of text-based tokens and a plurality of motion tokens;
appending a plurality of masked tokens to the plurality of motion tokens;
performing a masked transformer routine to generate a plurality of predicted motion tokens based on the plurality of masked tokens, the plurality of motion tokens, and the plurality of text-based tokens;
decoding the plurality of predicted motion tokens and the plurality of motion tokens into a motion sequence of the character, wherein the motion sequence comprises the one or more motions and a predicted motion of the character; and
controlling the character in the virtual environment based on the motion sequence.

2. The system of claim 1, wherein the instructions for performing the masked transformer routine further comprise:
generating a first predicted value of each of the plurality of masked tokens;
determining a first confidence score associated with the first predicted value of each of the plurality of masked tokens; and
converting a first set of the plurality of masked tokens having the first confidence score that is greater than or equal to a first threshold confidence score to the plurality of predicted motion tokens.

3. The system of claim 2, wherein the instructions for performing the masked transformer routine further comprise:
masking, based on a mask scheduling routine and using the first set of the plurality of masked tokens as an input condition, a subset of a second set of the plurality of masked tokens having the first confidence score that is less than a second threshold confidence score; and
generating, based on a stochastic sampling routine, one or more second predicted values associated with the subset of the second set of the plurality of masked tokens and one or more second confidence scores that are respectively associated with the one or more second predicted values; and
converting at least a portion of the subset of the second set of the plurality of masked tokens having a second confidence score of the one or more second confidence scores that is greater than or equal to the second threshold confidence score to the plurality of predicted motion tokens.

4. The system of claim 3, wherein the stochastic sampling routine is a temperature sampling routine, a top-k sampling routine, or a top-p sampling routine.

5. The system of claim 3, wherein the mask scheduling routine is a cosine function, a linear function, or a square root function.

6. The system of claim 3, wherein the second threshold confidence score is less than the first threshold confidence score.

7. The system of claim 1, wherein the plurality of text-based tokens comprise a word token and a sentence token.

8. The system of claim 1, wherein the one or more motions comprise a first motion and a second motion, and wherein the predicted motion is between the first motion and the second motion.

9. The system of claim 1, wherein the one or more motions comprise a first motion, and wherein the predicted motion is between a first portion of the first motion and a second portion of the first motion.

10. The system of claim 1, wherein:
the text input indicates a lower-body motion of the character and an upper-body motion of the character;
the plurality of motion tokens comprise a plurality of lower-body motion tokens and a plurality of upper-body motion tokens;
the instructions for appending the plurality of masked tokens to the plurality of motion tokens further comprise appending the plurality of masked tokens to the plurality of lower-body motion tokens;
the plurality of predicted motion tokens are a plurality of predicted lower-body motion tokens that are generated based on the plurality of masked tokens, the plurality of lower-body motion tokens, and the plurality of text-based tokens;
the instructions further comprise concatenating the plurality of lower-body motion tokens, the plurality of predicted lower-body motion tokens, and the plurality of upper-body motion tokens into a sequence of motion tokens; and
the instructions for decoding the plurality of predicted motion tokens and the plurality of motion tokens into the motion sequence of the character further comprise decoding the sequence of motion tokens into the motion sequence of the character.

11. A system for training a masked transformer system configured to control a character in a virtual environment, the system comprising:
at least one processor; and
at least one nontransitory computer-readable medium comprising instructions that are executable by the at least one processor, wherein the instructions comprise:
training a variational autoencoder to generate a plurality of motion tokens based on a plurality of training text inputs;
appending a plurality of text-based tokens to the plurality of motion tokens;
replacing a set of the plurality of motion tokens with a plurality of masked tokens;
performing, by a masked transformer comprising one or more attention layers, a masked transformer routine to generate a plurality of reconstructed motion tokens based on the plurality of masked tokens, the plurality of motion tokens, and the plurality of text-based tokens; and
selectively modifying one or more parameters of the one or more attention layers based on a difference between the set of the plurality of motion tokens and the plurality of reconstructed motion tokens.

12. The system of claim 11, wherein the variational autoencoder is a vector quantized variational autoencoder that is trained based on a motion codebook comprising a plurality of reference codes.

13. The system of claim 12, wherein the instructions for training the vector quantized variational autoencoder to generate the plurality of motion tokens based on the plurality of training text inputs further comprise:
encoding the plurality of training text inputs into the plurality of motion tokens based on at least one reference code of the plurality of reference codes, wherein the plurality of motion tokens are a latent space representation of a desired motion of the character;
decoding the plurality of motion tokens to generate reconstructed training text; and
selectively modifying one or more parameters of the variational autoencoder based on a difference between the reconstructed training text and the plurality of training text inputs.

14. The system of claim 11, wherein the one or more attention layers comprise one or more self-attention layers and a cross-attention layer.

15. The system of claim 11, wherein the difference between the plurality of motion tokens and the plurality of reconstructed motion tokens is further based on a reconstruction probability generated by the masked transformer or a reconstruction confidence value generated by the masked transformer.

16. A method for controlling a character in a virtual environment, the method comprising:
executing, by at least one processor, computer program instructions stored in a non-transitory computer-readable storage medium to perform operations comprising:
receiving a text input indicating one or more motions of the character;
generating, based on the text input, a plurality of text-based tokens and a plurality of motion tokens;
performing a masked transformer routine to generate a plurality of predicted motion tokens based on a plurality of masked tokens, the plurality of motion tokens, and the plurality of text-based tokens;
decoding the plurality of predicted motion tokens and the plurality of motion tokens into a motion sequence of the character, wherein the motion sequence comprises the one or more motions and a predicted motion of the character; and
controlling the character in the virtual environment based on the motion sequence.

17. The method of claim 16, wherein performing the masked transformer routine further comprises:
generating a first predicted value of each of the plurality of masked tokens;
determining a first confidence score associated with the first predicted value of each of the plurality of masked tokens; and
converting a first set of the plurality of masked tokens having the first confidence score that is greater than or equal to a first threshold confidence score to the plurality of predicted motion tokens.

18. The method of claim 17, wherein performing the masked transformer routine further comprises:
masking, based on a mask scheduling routine and using the first set of the plurality of masked tokens as an input condition, a subset of a second set of the plurality of masked tokens having the first confidence score that is less than a second threshold confidence score; and
generating, based on a stochastic sampling routine, one or more second predicted values associated with the subset of the second set of the plurality of masked tokens and one or more second confidence scores that are respectively associated with the one or more second predicted values; and
converting at least a portion of the subset of the second set of the plurality of masked tokens having a second confidence score of the one or more second confidence scores that is greater than or equal to the second threshold confidence score to the plurality of predicted motion tokens.

19. The method of claim 16, further comprising appending the plurality of masked tokens to the plurality of motion tokens.

20. A computer program product comprising a non-transitory storage medium comprising computer-readable instructions therein, which, when executed by at least one processor, causes the at least one processor to perform the method of claim 16.
